(19) United States
(12) Patent Application Publication
(10) Pub. No.: US 2018/0013524 A1
(43) Pub. Date: Jan. 11, 2018

(54) MACRO CELL, SMALL CELL AND USER EQUIPMENT FOR MOBILE COMMUNICATION SYSTEM

(71) Applicant: Institute For Information Industry, Taipei (TW)

(72) Inventors: Chun-Che CHIEN, Taipei City (TW); Chia-Hung WEI, Taipei City (TW); Hai-Han WANG, Taipei City (TW)

(21) Appl. No.: 15/646,770

(22) Filed: Jul. 11, 2017

Related U.S. Application Data
(60) Provisional application No. 62/360,948, filed on Jul. 11, 2016.

(51) Int. Cl. H04L 5/00; H04W 74/08; H04W 84/04

(52) U.S. Cl. CPC H04L 5/005; H04W 74/0833; H04W 84/045

(57) ABSTRACT

A macro cell, a small cell and a user equipment for a mobile communication system are provided. The mobile communication system includes the macro cell and a plurality of small cells. The macro cell stores first essential system information of itself, and performs the following operations: determining common system information between the macro cell and the small cells; storing the common system information; generating a primary system information message carrying the first essential system information and the common system information; and broadcasting the primary system information message periodically. In addition, when the user equipment is to obtain secondary system information (or called dedicated service system information) of the macro cell or the small cell, the user equipment may obtain the secondary system information by further transmitting a dedicated system information request message to the macro cell or the small cell.

### PRIORITY

This application claims priority to U.S. Provisional Application Ser. No. 62/360,948 filed on Jul. 11, 2016, which is hereby incorporated by reference in its entirety.

### FIELD

The present invention relates to a macro cell, a small cell and a user equipment (UE) for a mobile communication system. Particularly, the macro cell of the present invention periodically transmits a primary system information message comprising common system information between the macro cell and a plurality of small cells to reduce radio resources necessary for the macro cell and the small cells to transmit their own system information respectively.

### BACKGROUND

In current mobile communication systems, a user equipment (UE) which is to connect to a base station and request a specific service therefrom must first receive system information broadcasted by the base station to obtain system information necessary for subsequently connecting to the base station and requesting the specific service therefrom.

In the current mobile communication systems, base stations (including macro cells and small cells) broadcast their own essential system information respectively. The great amount of system information periodically broadcasted consumes a large amount of system resources, e.g., radio resources and power. Taking a Long Term Evolution (LTE) mobile communication system as an example, 20 system information blocks (SIBs) must be broadcasted periodically and continuously, so the broadcasted information amount leads to great consumption of the system resources. As base stations are deployed at a high density nowadays, transmission of system information between different base stations not only wastes the system resources, but also leads to signal interferences with each other. The number of SIBs that need be broadcasted periodically and continuously as specified in the current mobile communication systems will limit possibilities of back compatibility of the further mobile communication systems. In other words, if a future mobile communication system is to be back compatible with a current mobile communication system, the future mobile communication system must allocate the same radio resources to these SIBs that need be transmitted periodically and continuously. For example, if back compatibility with the LTE mobile communication system is desired, then the future mobile communication system must reserve the same radio resources for the 20 SIBs that need be broadcasted periodically and continuously.

Accordingly, an urgent need exists in the art to provide a system information transmission mechanism for the next generation of mobile communication systems (which are commonly known as “5G mobile communication system”) to reduce the number of SIBs and the information amount that need be broadcasted periodically and continuously so that consumption of system resources and signal interferences between base stations can be reduced and the possibility of back compatibility of future mobile communication systems can be maximized

### SUMMARY

An objective of certain embodiments of the present invention is to provide a system information transmission mechanism in which a macro cell in the mobile communication system determines common system information between the macro cell and a plurality of small cells, generates primary system information carrying the common system information and first essential system information of the macro cell, and periodically transmits the primary system information. Thereby, when the system information transmission mechanism is applied to the next generation of mobile communication systems, the number of SIBs and the information amount that need be broadcasted periodically and continuously can be reduced so as to reduce the consumption of system resources and signal interferences between base stations and to maximize the possibility of back compatibility of future mobile communication systems.

The disclosure includes a macro cell for a mobile communication system. The mobile communication system comprises the macro cell and a plurality of small cells. The macro cell comprises a transceiver, a storage and a processor. The storage is configured to store first essential system information of the macro cell. The processor is electrically connected to the transceiver and the storage, and is configured to execute the following operations: determining common system information between the macro cell and the small cells; storing the common system information into the storage; generating primary system information message that carries the first essential system information and the common system information; and periodically transmitting the primary system information message via the transceiver.

The disclosure also includes a user equipment (UE) for a mobile communication system. The mobile communication system comprises a macro cell and a plurality of small cells. The UE comprises a transceiver, a storage and a processor. The processor is electrically connected to the transceiver and the storage, and is configured to execute the following operations: receiving a primary system information message from the macro cell via the transceiver; generating a dedicated service system information request message according to the primary system information message; and transmitting the dedicated service system information request message to a target small cell among the small cells via the transceiver so that the target small cell transmits a dedicated service system information message through periodical broadcasting within a specific time interval or transmits the dedicated service system information message through dedicated signaling. The mobile communication system provides a plurality of dedicated service types. The primary system information message comprises common system information between the macro cell and the small cells, first essential system information of the macro cell, and second essential system information.

The second essential system information of each of the small cells comprises service summary information indicating at least one of the service types provided by each of the corresponding small cell.

The disclosure further includes a small cell for a mobile communication system. The mobile communication system comprises a macro cell, the small cell and a plurality of other small cells. The small cell comprises a transceiver, a storage and a processor. The processor is electrically connected to the transceiver and the storage, and is configured to receive a dedicated service system information request message via the transceiver, and transmit a dedicated service system information message through periodical broadcasting within a specific time interval or transmit the dedicated service system information message through dedicated signaling according to the dedicated service system information request message. The UE receives a primary system information message from the macro cell to generate the dedicated service system information request message according to the primary system information message. The mobile communication system provides a plurality of dedicated service types. The primary system information message comprises common system information between the macro cell and the small cell as well as the other small cells, first essential system information of the macro cell, second essential system information of the small cell and second essential system information of each of the other small cells. The second essential system information of the small cell comprises service summary information indicating at least one of the dedicated service types provided by the small cell, and the second essential system information of each of the other small cells comprises service summary information indicating at least one of the dedicated service types provided by the corresponding other small cells.

The disclosure additionally includes a small cell for a mobile communication system. The mobile communication system comprises a macro cell, the small cell and a plurality of other small cells. The mobile communication system provides a plurality of dedicated service types. The UE receives a primary system information message from the macro cell. The primary system information message comprises common system information between the macro cell and the small cell as well as the other small cells and first essential system information of the macro cell. The small cell comprises a transceiver, a storage and a processor. The processor is electrically connected to the transceiver and the storage, and is configured to transmit another primary system information message via the transceiver, receive a dedicated service system information request message from a UE, and transmit a dedicated service system information message through periodical broadcasting within a specific time interval or transmit the dedicated service system information message through dedicated signaling according to the dedicated service system information request message. The another primary system information message comprises second essential system information and excludes the common system information The second essential system information comprises service summary information indicating at least one of the dedicated service types provided by the small cell.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIGS. 1A-1B depict an implementation scenario of a mobile communication system MCS and a UE 2 according to the present invention;

FIGS. 2A-2C depict different implementation scenarios in which the UE 2 requests dedicated service system information from a small cell 3;

FIGS. 3A-3C depict different implementation scenarios in which the UE 2 requests dedicated service system information via the macro cell 1;

FIGS. 4A-4C depict different implementation scenarios in which the UE 2 uses different preamble groups in a same physical random access channel to request dedicated service system information from the macro cell 1 or the small cell 3;

FIGS. 5A-5C depict different implementation scenarios in which the UE 2 uses dedicated preambles 2032, 2034 to request dedicated service system information from the small cell 3 and performs a timing advance correction;

FIGS. 6A-6C depict different implementation scenarios in which the UE 2 requests dedicated service system information from the small cell 3;

FIG. 7 is a schematic view of the macro cell 1 according to the present invention;

FIG. 8 is a schematic view of the UE 2 according to the present invention; and

FIG. 9 is a schematic view of the small cell 3 according to the present invention.

### DETAILED DESCRIPTION

In the following description, certain embodiments the present invention will be explained with reference to example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

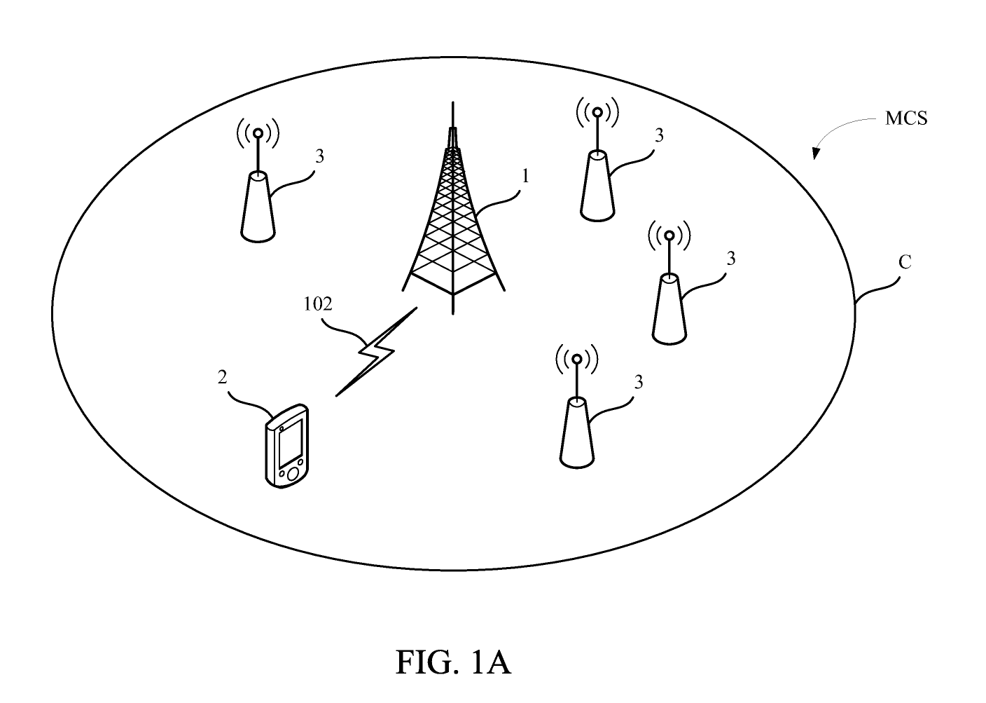

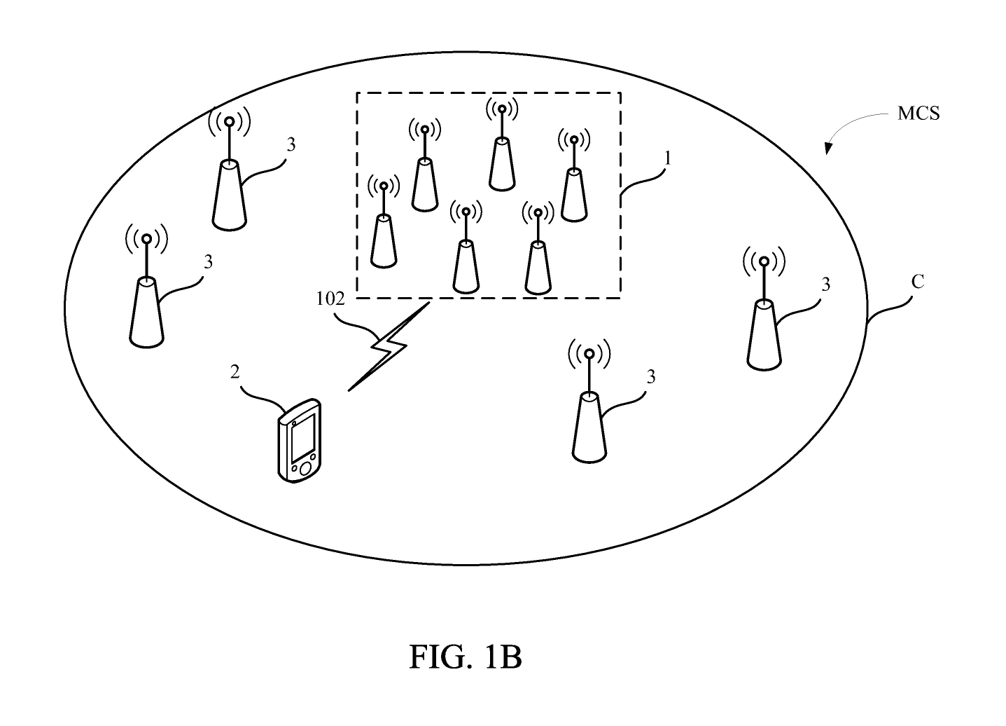

A first embodiment of the present invention is shown in FIGS. 1A-1B. FIGS. 1A-1B depict an implementation scenario of a mobile communication system MCS and a UE 2 according to the present invention. In an implementation scenario shown in FIG. 1A, the mobile communication system MCS comprises a macro cell 1 and a plurality of small cells 3.

The small cells 3 are usually located within a signal coverage C of the macro cell 1, but in some specific applications, there may be a small cell 3 that is not located within the signal coverage of the macro cell 1. Additionally, in an implementation scenario shown in FIG. 1B, the macro cell 1 is a virtual macro cell consisting of a plurality of specific small cells, and a signal coverage formed by these specific small cells together is also represented by the signal coverage C. Because how a virtual macro cell is formed by multiple small cells and the substantial differences between the macro cell 1 and the small cells 3 can be appreciated by those of ordinary skill in the art, these will not be further described herein.

The macro cell 1 stores first essential system information of itself, and determines common system information between the macro cell 1 and the small cells 3. The common system information refers to a common part of system information that need be broadcasted periodically and continuously among base stations (including macro cell and small cells) in the mobile communication system. For example, the common system information may be one of a system channel bandwidth, a base station re-selection parameter, emergency information, and any combination thereof.

The macro cell 1 stores the common system information and generates a primary system information message 102. The primary system information message 102 carries the first essential system information and the common system information. Then, the macro cell 1 periodically broadcasts the primary system information message 102. When the macro cell 1 is a virtual macro cell consisting of a plurality of specific small cells, the primary system information message 102 may be periodically transmitted by all of these specific small cells, or by a part of the specific small cells in consideration of reducing the overall power consumption and of regional movement or clustering of UEs. The periodical broadcasting may be transmitted by Master Information Blocks (MIBs) and/or SIBs (SIBs) just as in the LTE mobile communication system. Accordingly, by periodically broadcasting the common system information of the small cells 3 and the macro cell 1 via the macro cell 1 altogether, system information that need be broadcasted periodically and continuously by the small cells 3 can be reduced so as to reduce the system resource consumption.

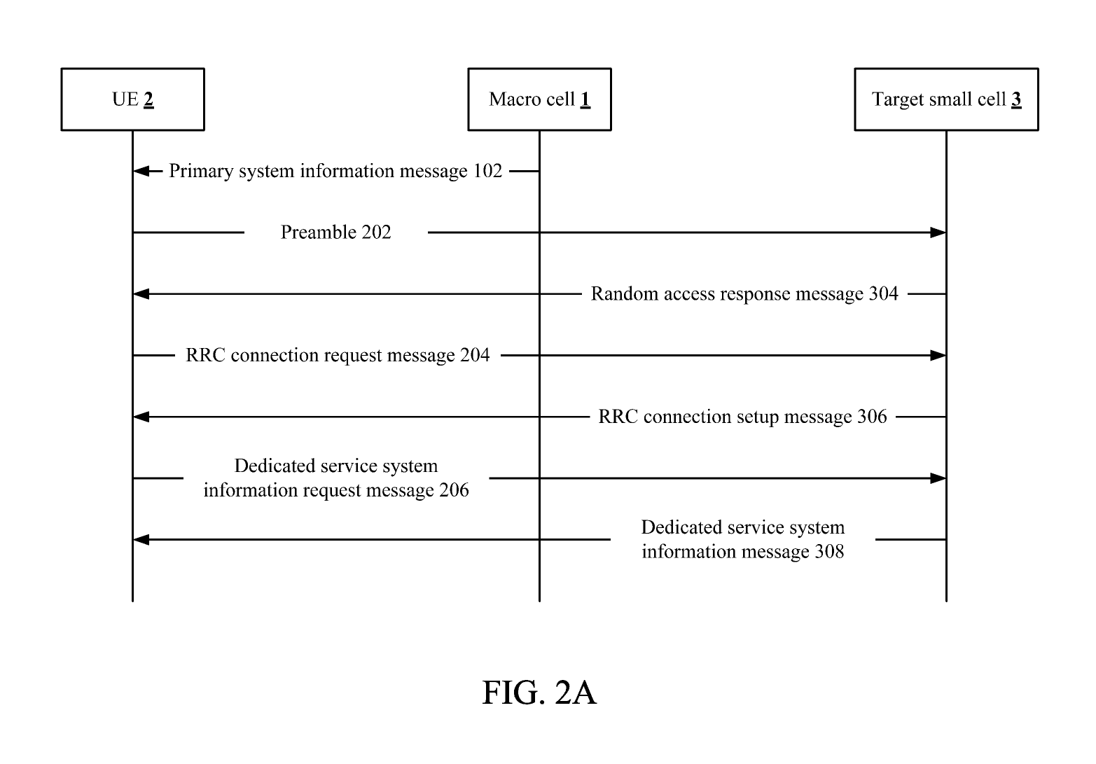

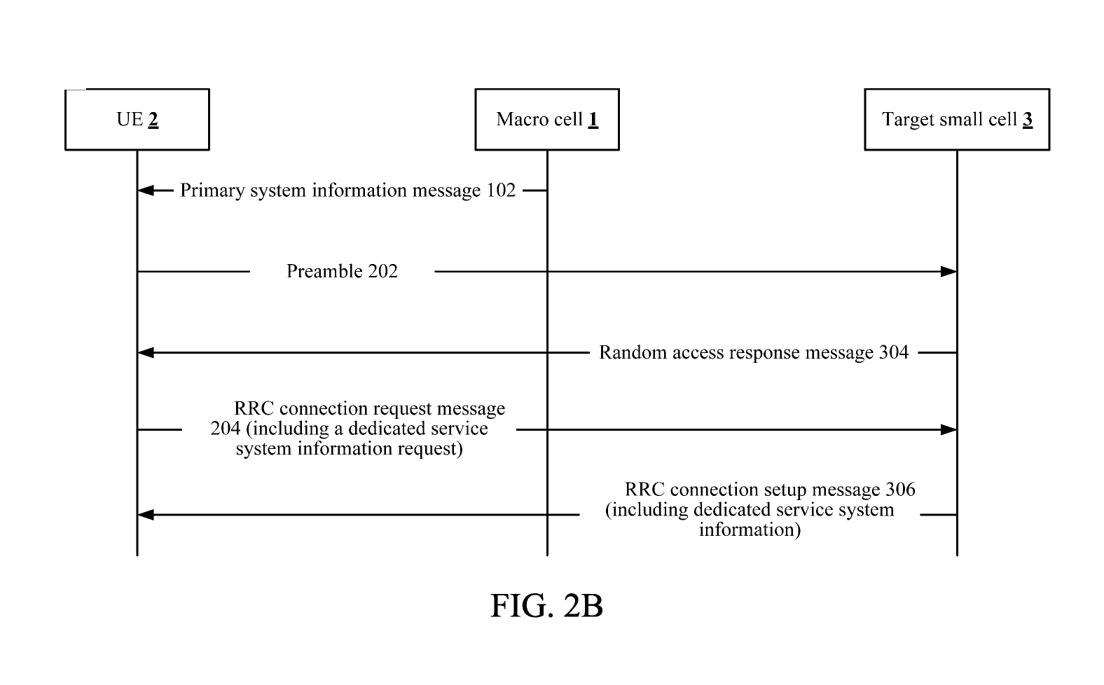

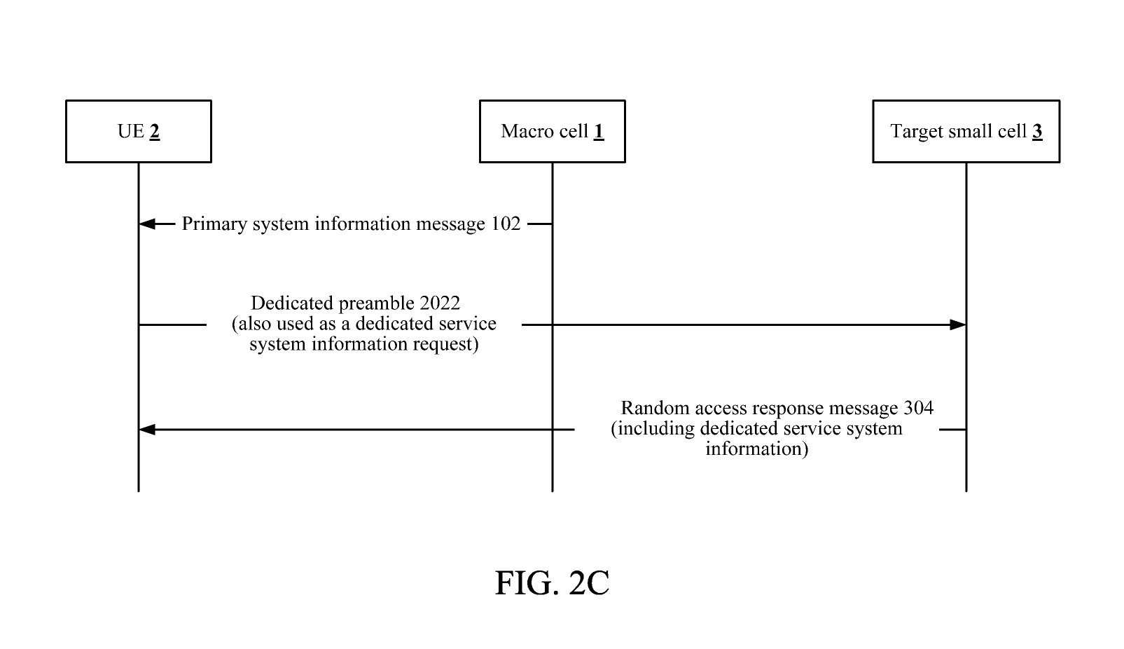

It shall be noted that, in an implementation scenario, the macro cell 1 may connect to each of the small cells 3 via a backhaul network, so a control device of the backhaul network can determine whether there is common system information, and transmit control information from the backhaul network to the macro cell 1 for the macro cell 1 to determine the common system information according to the control information. On the other hand, in an implementation scenario, the macro cell 1 may connect to each of the small cells 3 directly (e.g., via an optical fiber cable) to control each of the small cells 3 directly, in which case the macro cell 1 may determine whether there is common system information directly. A second embodiment of the present invention is shown in FIGS. 2A-2C. The second embodiment is an extension of the first embodiment. FIGS. 2A-2C depict different implementation scenarios in which the UE 2 requests dedicated service system information from a small cell 3. The mobile communication system provides a plurality of dedicated service types. Unlike the prior art where base stations broadcast the dedicated service system information periodically and continuously, the dedicated service system information (also called “secondary system information”) is provided to the UE 2 only if it is requested by the UE 2 in the present invention.

In this embodiment, the primary system information message 102 further carries second essential system information of each of the small cells 3 in addition to the common system information and the first essential system information of the macro cell 1. The first essential system information of the macro cell 1 may comprise first initial access information, first information to access other SIBs, first service summary information, first service relevant SIBs status information and a first system information change indication. The second essential system information of each of the small cells 3 may comprise second initial access information, second information to access other SIBs, second service summary information, second service relevant SIBs status information and a second system information change indication.

For example, the first initial access information may comprise physical random access channel (PRACH) resource information indicating information related to preamble transmission and an indication of an access restriction status of the macro cell 1. The first information to access other SIBs may be a resource location and a period at which the macro cell 1 transmits other SIBs. The first service summary information indicates at least one of the dedicated service types provided by the macro cell 1. The first service relevant SIBs status information indicates whether a service content of the dedicated service type supported by the macro cell 1 is being broadcasted by the macro cell 1. The first system information change indication is used to inform the UE 2 of whether the system information has been updated.

Similarly, the second initial access information may comprise PRACH resource information indicating information related to preamble transmission and an indication of an access restriction status of the small cell 3. The second information to access other SIBs may be a resource location and a period at which the small cell 3 transmits other SIBs. The second service summary information indicates at least one of the dedicated service types provided by the small cell 3. The second service relevant SIBs status information indicates whether a service content of the dedicated service type supported by the small cell 3 is being broadcasted by the small cell 3. The second system information change indication is used to inform the UE 2 of whether the system information has been updated.

For example, the dedicated service types may include a device-to-device (D2D) service, an evolved multimedia broadcast multicast service (MBMS), a machine type communication (MTC) service, a vehicle-to-vehicle (V2V) service and an ultra-reliable and low latency communications (URLLC) service, but are not limited thereto. The following description focuses on how the UE 2 requests dedicated service system information from the small cell 3; however, how the UE 2 requests the dedicated service system information from the macro cell 1 can also be appreciated by those of ordinary skill in the art based on the description herein as well and will not be further described herein.

Referring to FIG. 2A, in this implementation scenario, the UE 2 that has received the primary system information message 102 transmitted by the macro cell 1 may select a small cell (called a “target small cell 3” hereinbelow) among the small cells 3 according to the second initial access information and the second service summary information of the small cells 3 and depending on the service needed by the UE 2, and perform a random access procedure with the target small cell 3 to obtain dedicated service system information of the target small cell 3.

For example, in the random access procedure, the UE 2 transmits a preamble 202 to the target small cell 3, and receives a random access response message 304 from the target small cell 3. Then the UE 2 transmits a Radio Resource Control (RRC) connection request message 204 to the target small cell 3 based on the random access response message 304, and receives an RRC connection setup message 306 from the target small cell 3. In this way, the UE 2 can establish an RRC connection with the target small cell 3 according to contents of the RRC connection setup message 306.

In FIG. 2A, the UE 2 may transmit a dedicated service system information request message 206 to the target small cell 3 via an uplink resource allocated by the target small cell 3 to the UE 2 (i.e., transmit the dedicated service system information request message 206 in an uplink data signal) in the RRC connection status. Because the dedicated service system information request message 206 is transmitted in the RRC connection status, it can be ensured that the dedicated service system information request message 206 is received by the target small cell 3. Accordingly, a dedicated service system information message 308 is transmitted through periodical broadcasting within a specific time interval or dedicated signaling so as to provide the dedicated service content to the UE 2. The periodical transmission may be done via MIBs or SIBs just as in the LTE mobile communication system. However, unlike the LTE mobile communication system, the present invention periodically broadcasts the dedicated service system information message 308 only within the specific time interval instead of continuously. The dedicated signaling may be one of unicast, multicast, and groupcast, but is not limited thereto.

Please refer next to FIG. 2B. In the implementation scenario depicted in FIG. 2B, the UE 2 transmits the dedicated service system information request message along with the RRC connection request message 204 to the target small cell 3 by merging the dedicated service system information request message into the RRC connection request message 204 (i.e. using the RRC connection request message 204 to carry the request contents or request instructions), and the target small cell 3 also transmits the dedicated service system information message along with an RRC connection setup message 306 to the UE 2 by merging the dedicated service system information message into the RRC connection setup message 306 (i.e. using the RRC connection setup message 306 to carry the dedicated service contents). In this way, the delay due to that the dedicated service content can only be obtained after the RRC connection is established can be shortened in this implementation scenario.

Refer next to FIG. 2C. In this implementation scenario, the plurality of preambles stored in the macro cell 1 further comprises a plurality of dedicated preambles 2022. The dedicated preambles 2022 have a correspondence relationship with the dedicated service types. The macro cell 1 may provide the correspondence relationship between the dedicated preambles 2022 and the dedicated service types to the UE 2 via the primary system information message 102. Additionally, the macro cell 1 may also provide the correspondence relationship to the small cells 3 via a backhaul network or a direct connection between the macro cell 1 and the small cells 3.

In this case, the UE 2 may further use a dedicated preamble 2022 as the dedicated service system information request message. After receiving the dedicated preamble 22, the small cell 3 can learn a dedicated service type requested by the UE 2 according the correspondence relationship and add the dedicated service system information of the dedicated service type needed by the UE 2 into the random access response message 304 for transmission to the UE 2 (i.e. using the random access response message 304 to carry the dedicated service contents). In this way, when the UE 2 has not established the RRC connection with the small cell 3 or is in the RRC idle status, the UE 2 can obtain the dedicated service system information early before the end of the random access procedure is ended. Accordingly, as compared with the implementation scenario shown in FIG. 2B, the implementation scenario shown in FIG. 2C further shortens the time necessary for obtaining the dedicated service system information. Additionally, in FIGS. 2B-2C, apart from merging the dedicated service system information message into the RRC connection setup message 306 or the random access response message 304 according to the time points at which the dedicated service system information request message is received, the target small cell 3 may also transmit the dedicated service system information message 308 through periodical broadcasting within a specific time interval or dedicated signaling as shown in FIG. 2A.

It shall be noted that, the above descriptions describe only signal transmissions between the UE 2 and the selected small cell 3 (i.e., the target small cell 3); however, as will be understood by those of ordinary skill in the art, the UE 2 may also select a plurality of small cells (i.e., there may be a plurality of target small cells 3) so that dedicated preambles 2022 are transmitted to different target small cells 3 respectively and random access response messages 304 transmitted back from the small cells 3 respectively to determine which of the target small cells 3 has resources that can satisfy the need of the UE 2 best, and then the UE 2 establishes an RRC connection with the determined target small cell 3. In other words, in FIG. 2C, the UE 2 transmits the RRC connection request message to the target small cell 3 only if the UE 2 determines to establish an RRC connection with the target small cell 3 after receiving the random access response message 304.

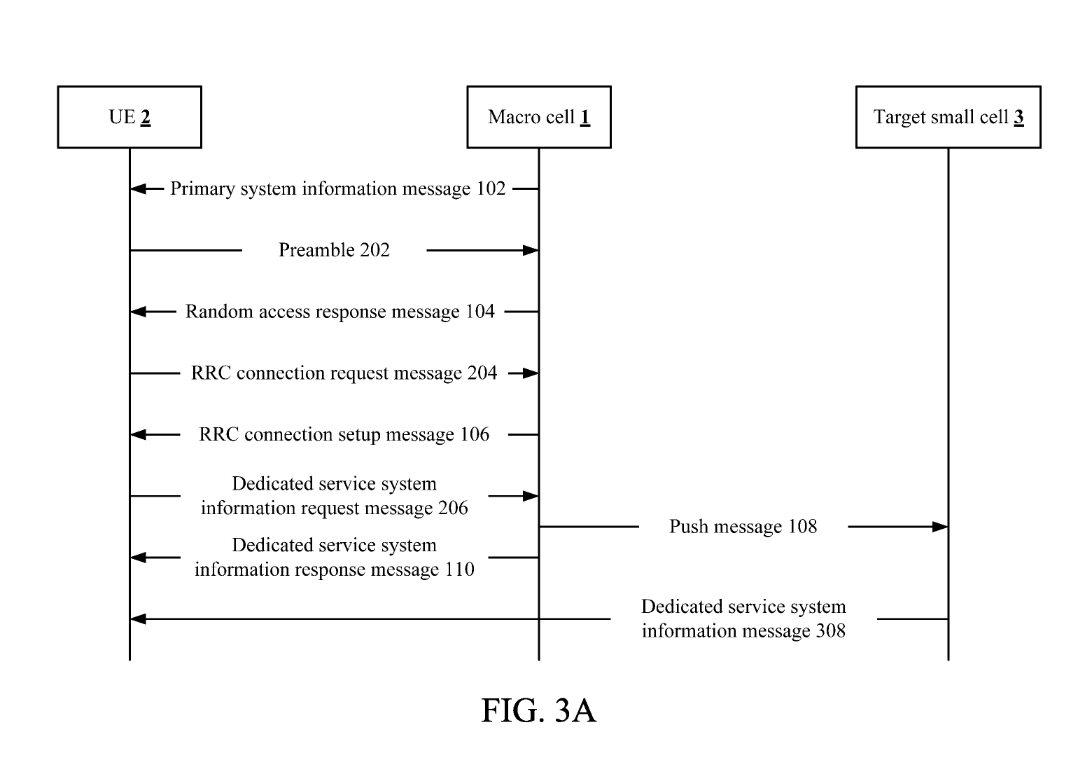

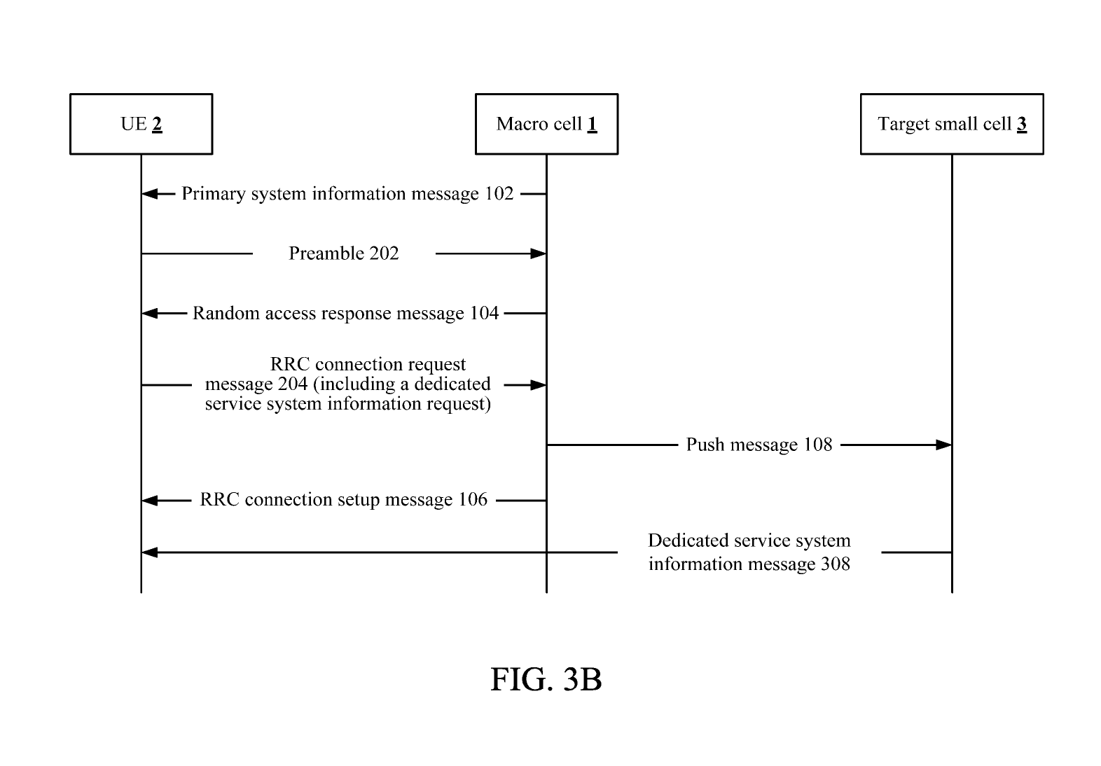

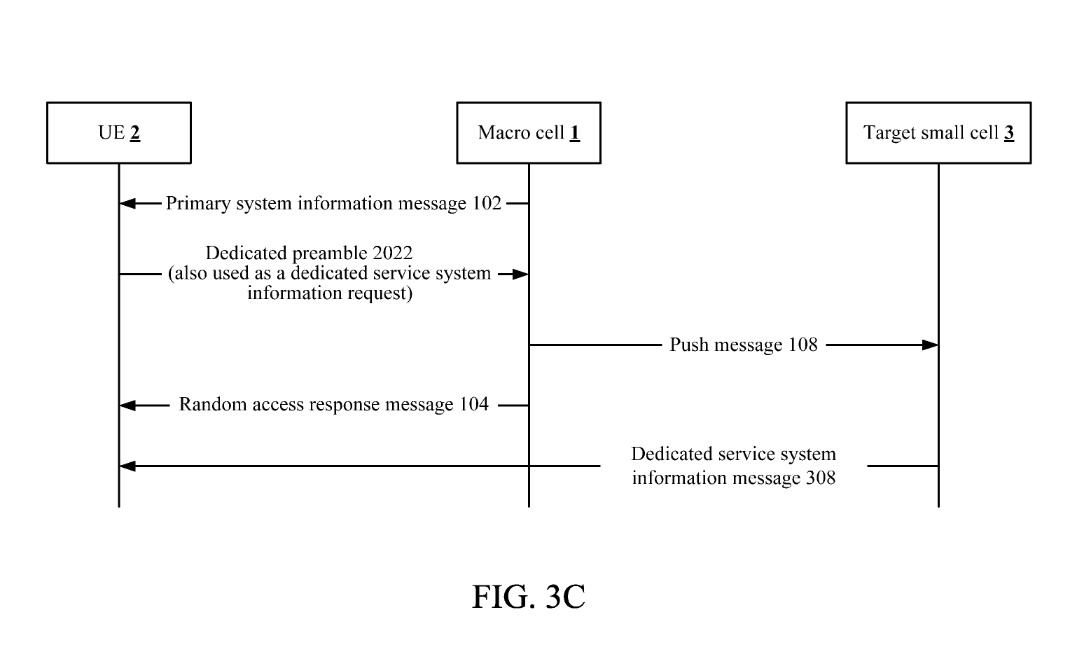

A third embodiment of the present invention is shown in FIGS. 3A-3C. The third embodiment is an extension of the first embodiment. FIGS. 3A-3C depict different implementation scenarios in which the UE 2 requests dedicated service system information via the macro cell 1. This embodiment differs from the second embodiment in that, in cases where the second essential system information is transmitted by the macro cell 1 instead of the small cells 3, the second initial access information of the second essential system information of each of the small cells 3 need not comprise PRACH resource information, and the UE 2 may obtain the necessary dedicated service system information via the macro cell 1 by performing a random access procedure with the macro cell 1. On the other hand, if the second essential system information is transmitted by each of the small cells 3 itself, the second initial access information still needs to comprise the PRACH resource information of the small cell 3.

It shall be appreciated that, the random access procedure of this embodiment only replaces the small cells 3 with the macro cell 1 as the object of the connection established through the random access procedure in the second embodiment. That is, the UE 2 transmits a preamble 202 to the macro cell 1, receives a random access response message 104 from the macro cell 1, transmits an RRC connection request message 204 to the macro cell 1, and receives an RRC setup message 106 from the macro cell 1. Because the random access procedure between the UE 2 and the macro cell 1 can be understood by those of ordinary skill in the art according to the aforesaid embodiments, it will not be further described herein.

Referring to FIGS. 3A-3B, the UE 2 generates a dedicated service system information request message 206 according to the second service summary information, where the dedicated service system information request message 206 indicates a target dedicated service type among the dedicated service types. After receiving the dedicated service system information request message 206 from the UE 2, the macro cell 1 selects at least one target small cell 3 that supports the target dedicated service type from the small cells 3 according to the target dedicated service type.

Then, the macro cell 1 generates a push message 108 which carries a dedicated service system information transmission indication of the target dedicated service type and generates a dedicated service system information response message 110 that carries an identity of each of the at least one target small cell 3, transmits the dedicated service system information response message 110 to the UE 2, and transmits the push message 108 to the target small cell 3 (e.g., via the X2 interface as defined in the LTE system) so that the target small cell 3 periodically broadcasts the dedicated service system information message 308 within a specific time interval according to the dedicated service system information transmission indication. The dedicated service system information message 308 carries dedicated service contents of the target dedicated service type.

Similarly in FIG. 3A, the dedicated service system information request message 206 is carried and transmitted in an uplink data signal in an RRC connection status by the UE 2 using uplink resources allocated by the macro cell 1. Additionally in FIG. 3B, the dedicated service system information request message 206 is merged into the RRC connection request message 204 of the random access procedure.

Please refer to FIG. 3C. Similarly, by designing the preambles to include a plurality of dedicated preambles and correspondence relationships between the dedicated preambles and the dedicated service types, each of the dedicated preambles 2022 can be used by the UE 2 as the dedicated service system information request message 206. After receiving one of the dedicated preambles from the UE 2, the macro cell 1 determines the target dedicated service type according to the correspondence relationship stored in the macro cell 1, and merges the dedicated service system information response message into the random access response message 104 for transmission to the UE 2. In other words, the random access response message 104 is also used as a dedicated service system information response message to comprise the identity of each of the at least one target small cell 3.

As can be known from the above descriptions, at least one target small cell 3 is selected by the macro cell 1 for the UE 2 and the dedicated service system information transmission indication of the target dedicated service type of the UE 2 is pushed to the at least one target small cell 3 in this embodiment, so the primary system information message 102 transmitted by the macro cell 1 need not comprise PRACH resource information of the small cells 3. In other words, the system information that need be transmitted by each of the small cells 3 is only the periodically broadcasted PRACH resource information of the small cell 3 itself and the dedicated service system information that is periodically broadcasted within the specific time interval in response to the request of the UE 2.

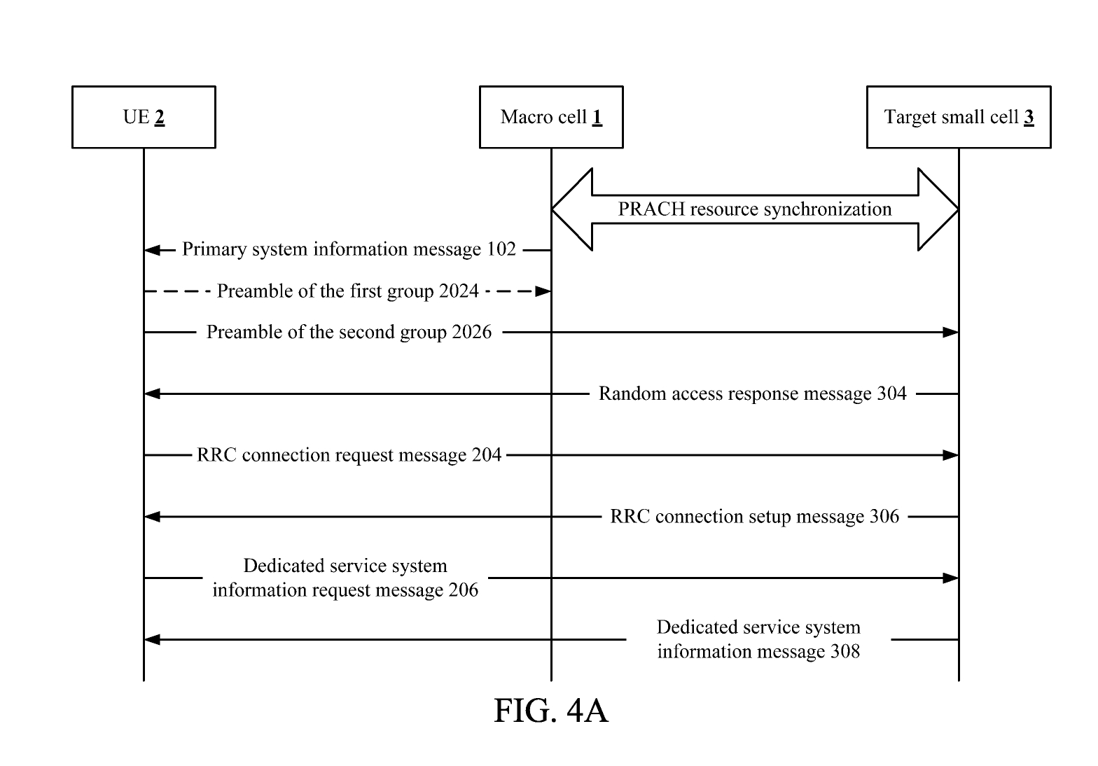

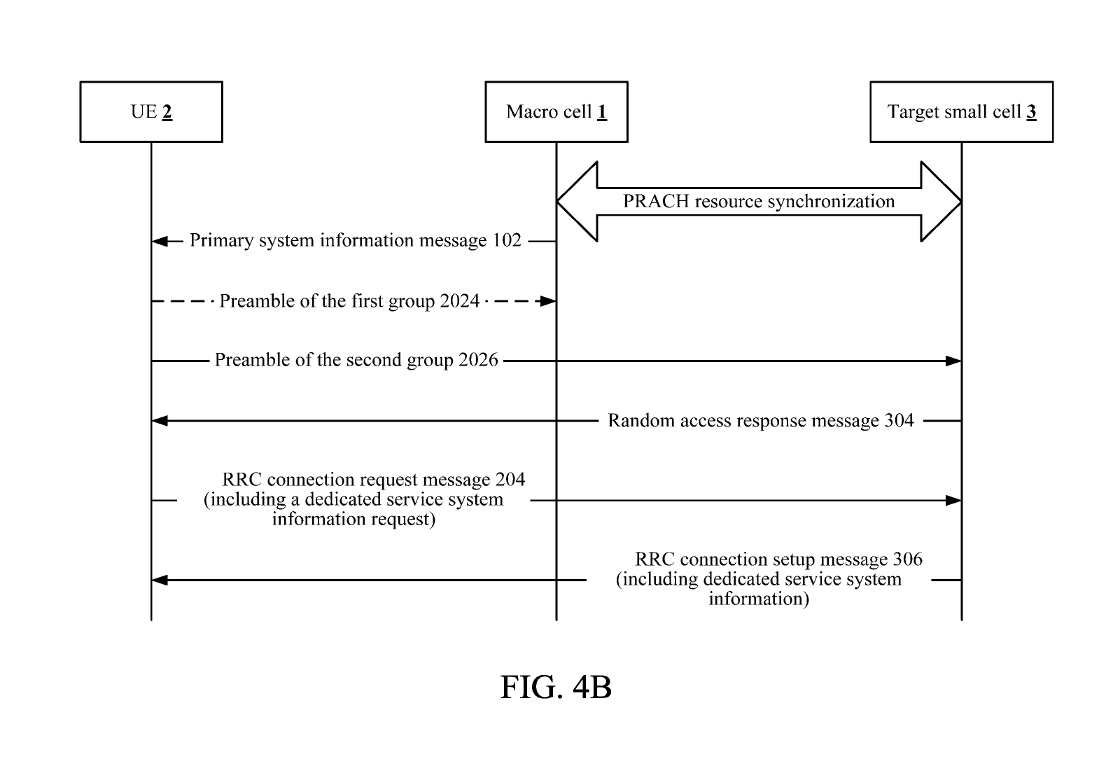

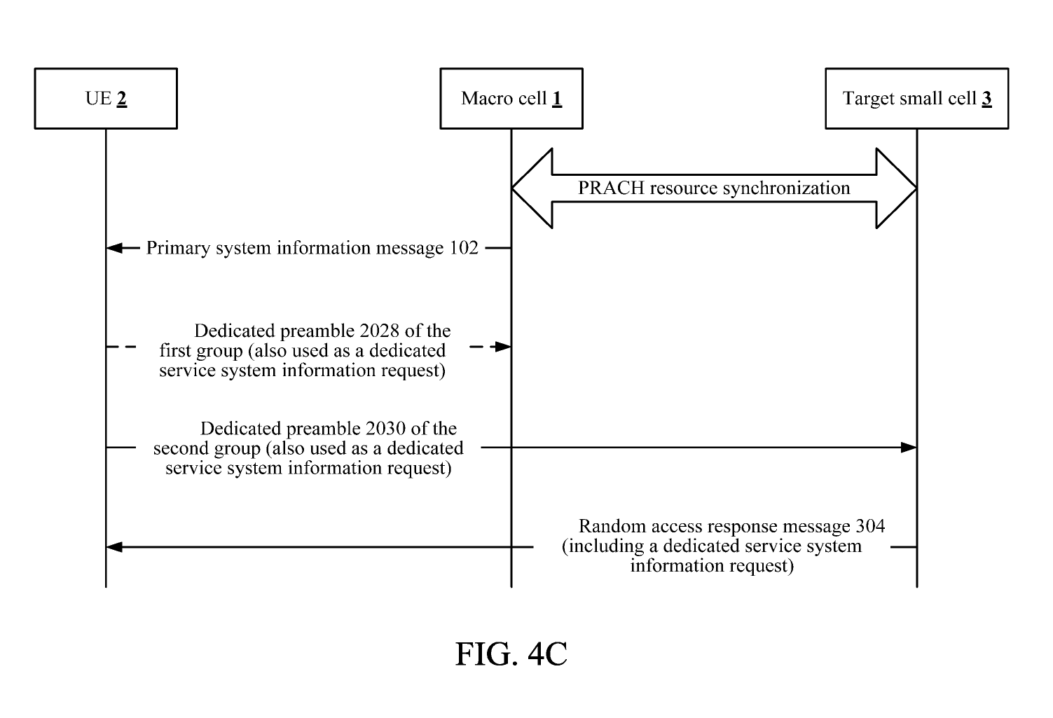

A fourth embodiment of the present invention is shown in FIGS. 4A-4C. The fourth embodiment is an extension of the second embodiment. FIGS. 4A-4C depict different implementation scenarios in which the UE 2 uses different preamble groups in a same physical random access channel to request dedicated service system information from the macro cell 1 or the small cell 3. In this embodiment, the PRACH resources between the macro cell 1 and the respective small cells 3 are synchronized, i.e., the PRACH resources used between the macro cell 1 and the respective small cells 3 are the same as each other.

For example, the macro cell 1 may request each of the small cells 3 to use a same radio resource as the PRACH. Because the primary system information message 102 transmitted by the macro cell 1 has already comprised the synchronized PRACH resource information, the second initial access information of the second essential system information of each of the small cells 3 need not comprise the PRACH resource information; that is, as the common system information between the macro cell 1 and the small cells and the synchronized PRACH resource information have been transmitted by the macro cell 1, the macro cell 1 need not additionally transmit the PRACH resource information of each of the small cells 3.

In this embodiment, the preambles of the mobile communication system MCS are further divided into a first group associated with the macro cell 1 and a second group associated with the small cells 3. If the UE 2 is to perform a random access procedure with the macro cell 1, one of the preambles 2024 in the first group may be selected; and on the other hand, if the UE 2 is to perform a random access procedure with the small cell 3, one of the preambles 2026 in the second group may be selected. This embodiment focuses on the UE 2 requesting dedicated service system information from the UE 2, so only signal transmissions between the UE 2 and the small cells 3 will be described hereinbelow. However, signal transmissions performed between the UE 2 and the macro cell 1 to request dedicated service system information from the macro cell 1 will also be understood by those of ordinary skill in the art based on the descriptions herein.

Referring first to FIGS. 4A-4B, the UE 2 transmits the preambles 2026 of the second group in PRACH. Because all the small cells 3 uses the same PRACH resources, each of the small cells 3 transmits a random access response message 304 back to the UE 2 after receiving the preambles 2026 of the second group from the UE 2. However, the UE 2 may be unable to connect with a plurality of small cells 3 simultaneously, so the UE 2 may only respond to the small cell 3 (called “the target small cell 3” hereinbelow) corresponding to a random access response message 304 that is first received, and subsequently perform a random access procedure with the target small cell 3.

As in the previous embodiment, the UE 2 may request the dedicated service system information from the target small cell 3 at different time points. As shown in FIG. 4A, the UE 2 transmits the dedicated service system information request message 206 from the target small cell 3 in an RRC connection status; or as shown in FIG. 4B, the UE 2 directly merges the dedicated service system information request message into the RRC connection request message 204 and the target small cell 3 merges the dedicated service system information message into the RRC connection setup message 306.

Referring next to FIG. 4C, the preambles 2026 of the second group further include a plurality of dedicated preambles 2030 which have a correspondence relationship with the dedicated service types. In this case, each of the dedicated preambles 2030 is also used as a dedicated service system information request message. Additionally, the preambles 2024 of the first group may also include a plurality of dedicated preambles 2028 which have a correspondence relationship with the dedicated service types of the macro cell 1, and when the UE 2 is to use the dedicated service type provided by the macro cell 1, each of the dedicated preambles 2030 may also be used as a dedicated service system information request message. Because how the dedicated preambles are used to obtain the dedicated service system information has already been detailed in the previous embodiments, it will not be further described herein.

In other implementations, the dedicated preambles 2030 included in the preambles 2026 of the second group may further have a correspondence relationship with the small cells 3. Then, the UE 2 may designate a target small cell 3 by transmitting a dedicated preamble 2030 so that the target small cell 3 can transmit back a random access response message 304. Because how the dedicated service system information is requested from the target small cell 3 based on the correspondence relationship between the dedicated preambles 2030 and the small cells 3 can be readily appreciated by those of ordinary skill from the above descriptions of the implementation scenarios of FIGS. 4A-4C, it will not be further described herein.

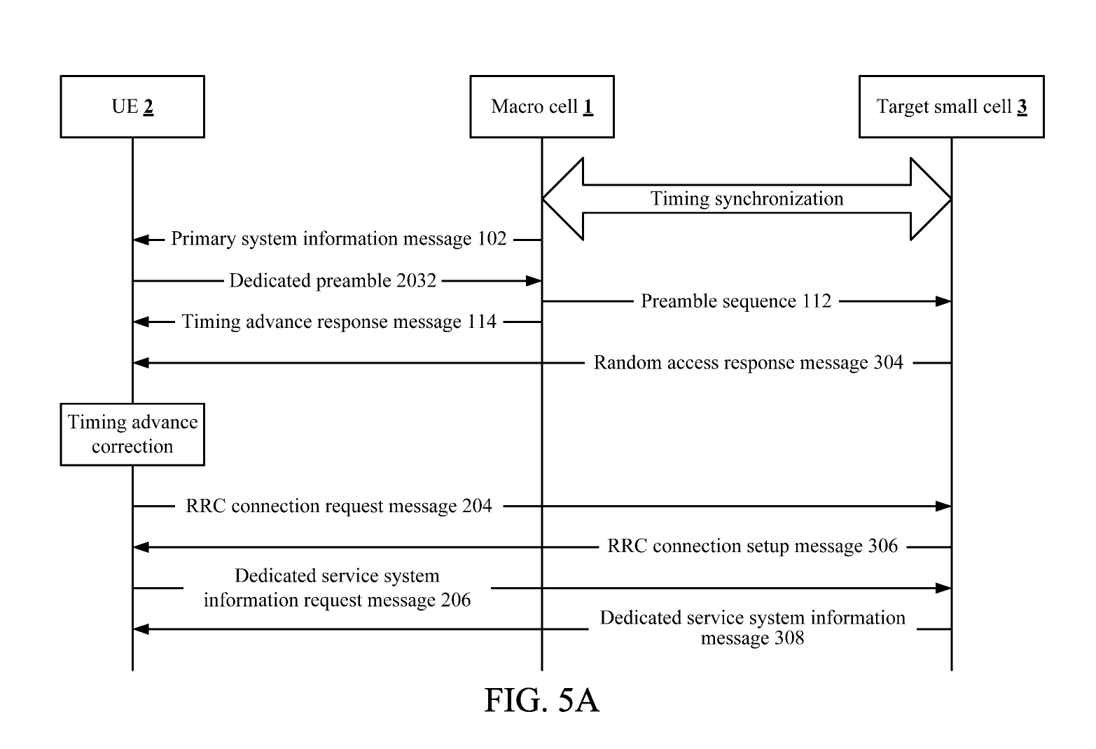

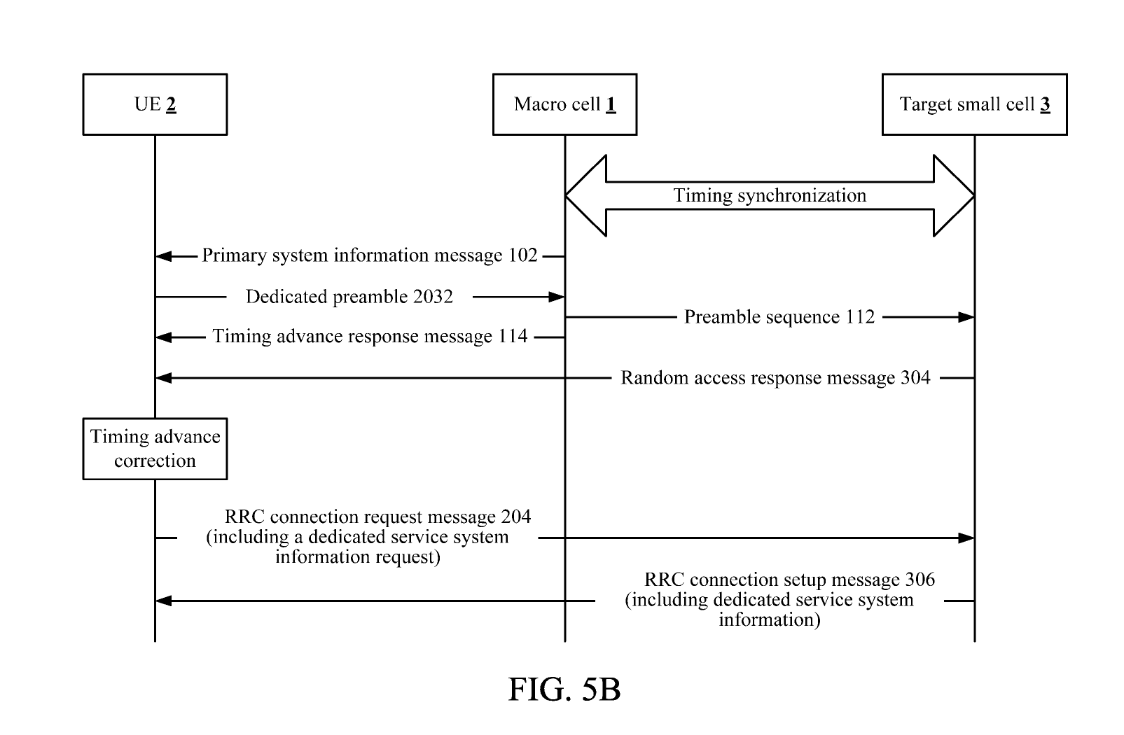

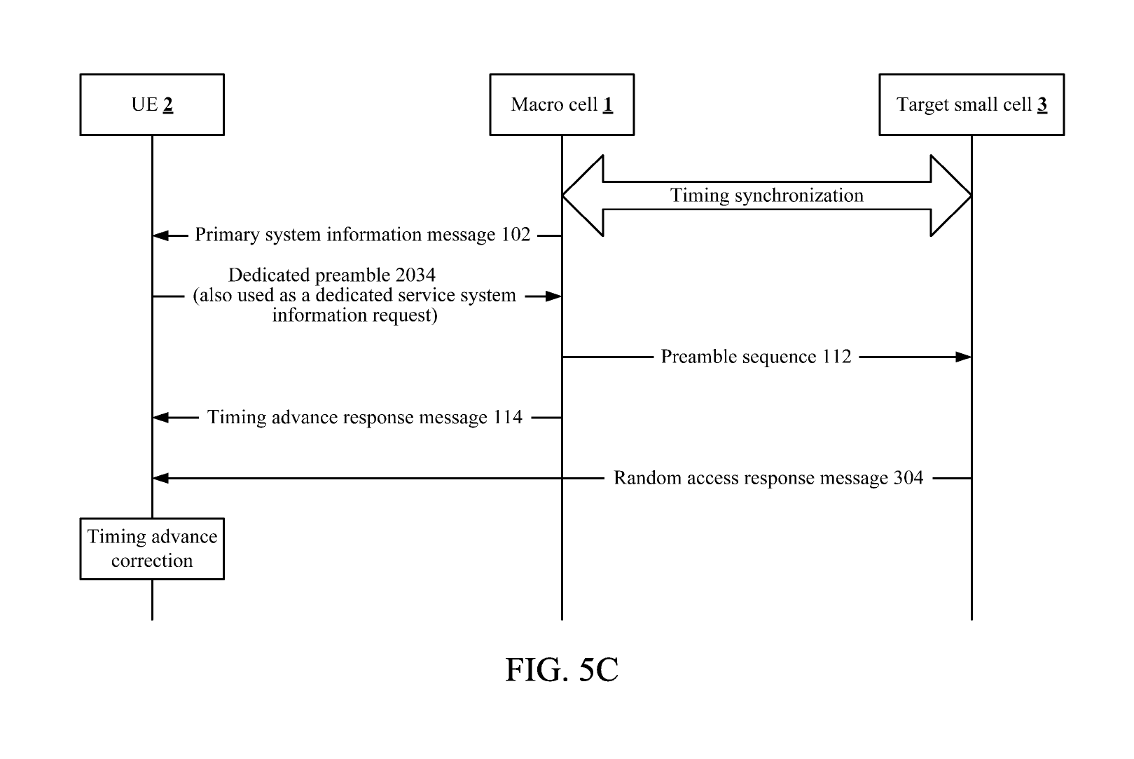

The fifth embodiment of the present invention is shown in FIGS. 5A-5C. The fifth embodiment is an extension of the first embodiment. FIGS. 5A-5C depict different implementation scenarios in which the UE 2 uses dedicated preambles 2032, 2034 to request dedicated service system information from the small cell 3 and performs a timing advance correction. In this embodiment, the macro cell 1 and each of the small cells 3 are in a timing synchronization status, and the second initial access information of the second essential system information of each of the small cells 3 in the primary system information message 102 transmitted by the macro cell 1 excludes PRACH resource information.

The timing synchronization represents that the macro cell 1 and the small cells 3 have the same frame transmission timings. The plurality of preambles of the mobile communication system further include a plurality of dedicated preambles 2032 which have a correspondence relationship with the small cells 3. The macro cell 1 provides the correspondence relationship to the UE 2 via the primary system information message 102. The UE 2 may indicate one of the small cells 3 (called “the target small cell 3” hereinbelow) by transmitting the dedicated preamble 2032.

The macro cell 1 receives the dedicated preamble 2032 transmitted by the UE 2 in the PRACH, parses a preamble sequence 112 of the dedicated preamble 2032, and transmits the preamble sequence 112 to the target small cell 3 (e.g., via the X2 interface as defined in the LTE system) based on the correspondence relationship so that the target small cell 3 transmits a random access response message 304 to the UE 2 according to the preamble sequence 112. It shall be appreciated that, if the macro cell 1 and the small cell 3 are connected via a backhaul network instead of a direct connection therebetween, the macro cell 1 transmits the preamble sequence 112 to the target small cell 3 via the backhaul network. On the other hand, if there is a direct connection (e.g., via an optical fiber cable) between the macro cell 1 and the small cell 3, then the macro cell 1 may transmit the preamble sequence 112 to the target small cell 3 directly.

Because the dedicated preamble 2032 is transmitted to the macro cell 1 via the UE 2 instead of being received by the target small cell 3 directly, the macro cell 1 transmits a timing advance response message 114 carrying a timing advance information to the UE 2 while the target small cell 3 is transmitting the random access response message 304. As a result, the UE 2 performs a timing advance correction according to a downlink timing, timing advance information, and a transmission time difference between the macro cell 1 and the target small cell 3. The UE 2 may calculate the transmission time difference according to a receipt time difference between receipt of the timing advance response message and receipt of the random access response message (but is not limited to this method).

FIGS. 5A-5C depicts that the UE 2 requests dedicated service system information of the target small cell 3 from the macro cell 1 at different time points. Referring to FIGS. 5A-5B, after performing the timing advance correction through the aforesaid steps, the UE 2 can transmit an RRC connection request message 204 to the target small cell 3 and receive an RRC connection setup message 306 from the target small cell so as to establish an RRC connection.

In FIG. 5A, with the RRC connection having been established, the UE 2 transmits the dedicated service system information request message 206 to the target small cell 3 so that the target small cell 3 transmits the dedicated service system information message 308 through periodical broadcasting within a specific time interval or transmits the dedicated service system information message 308 to the UE 2 through dedicated signaling. In FIG. 5B, the UE 2 loads the dedicated service system information request message 206 into the RRC connection request message 204 in the process of establishing the RRC connection.

Please refer next to FIG. 5C. In FIG. 5C, each of the dedicated preambles 2034 is also used as a dedicated service system information request message, so the dedicated preambles 2034 and the dedicated service types have another correspondence relationship therebetween. In other words, each of the dedicated preambles 2034 indicates both a target small cell and a dedicated service type. After receiving the dedicated preamble 2034, the macro cell 1 parses the preamble sequence 112 of the dedicated preamble 2034 and transmits the preamble sequence 112 to the target small cell 3. Once the preamble sequence 112 is received by the target small cell 3, the target small cell 3 can know the requested dedicated service type according to the correspondence relationships, merge the dedicated service system information message into the random access response message 304 and transmit the random access response message 304 to the UE 2. It shall be appreciated that, in FIG. 5C, if the UE 2 decides not to perform the subsequent random access procedure with the target small cell 3 after receiving the random access response message 304, the UE 2 will no need to perform the timing advance correction.

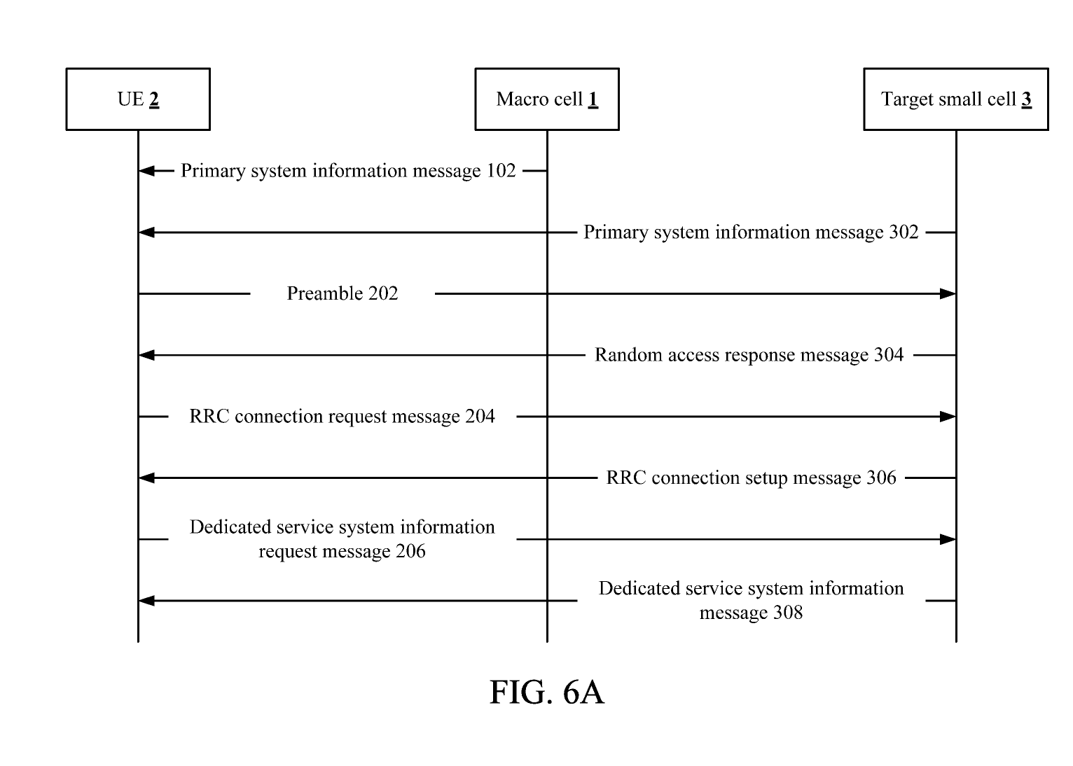

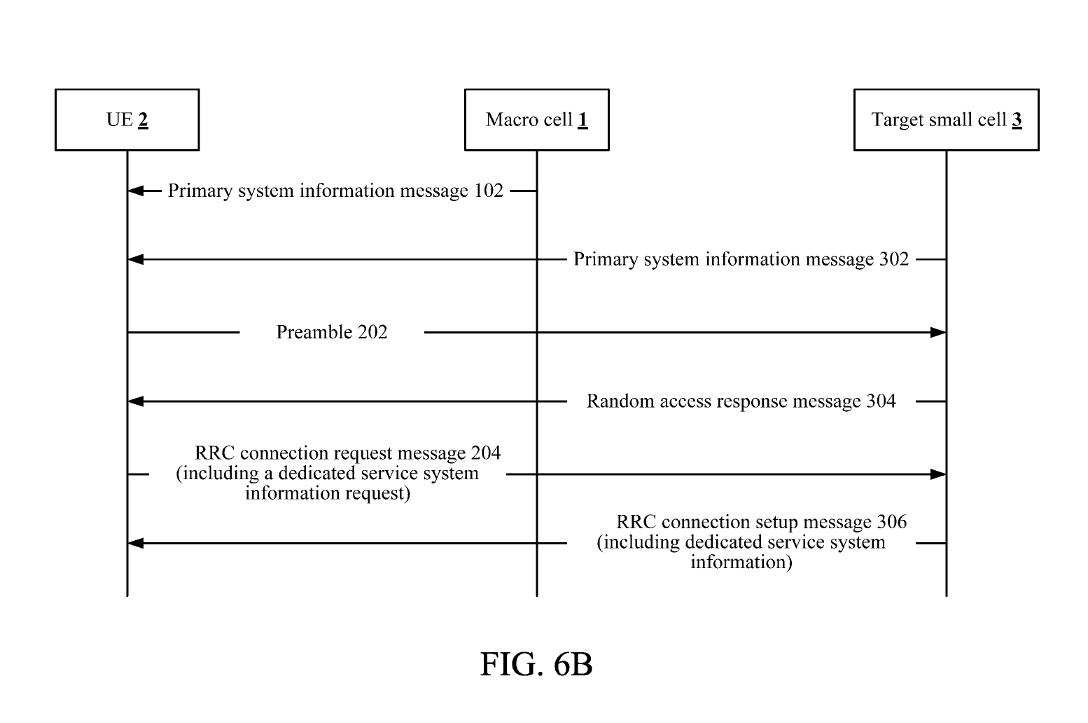

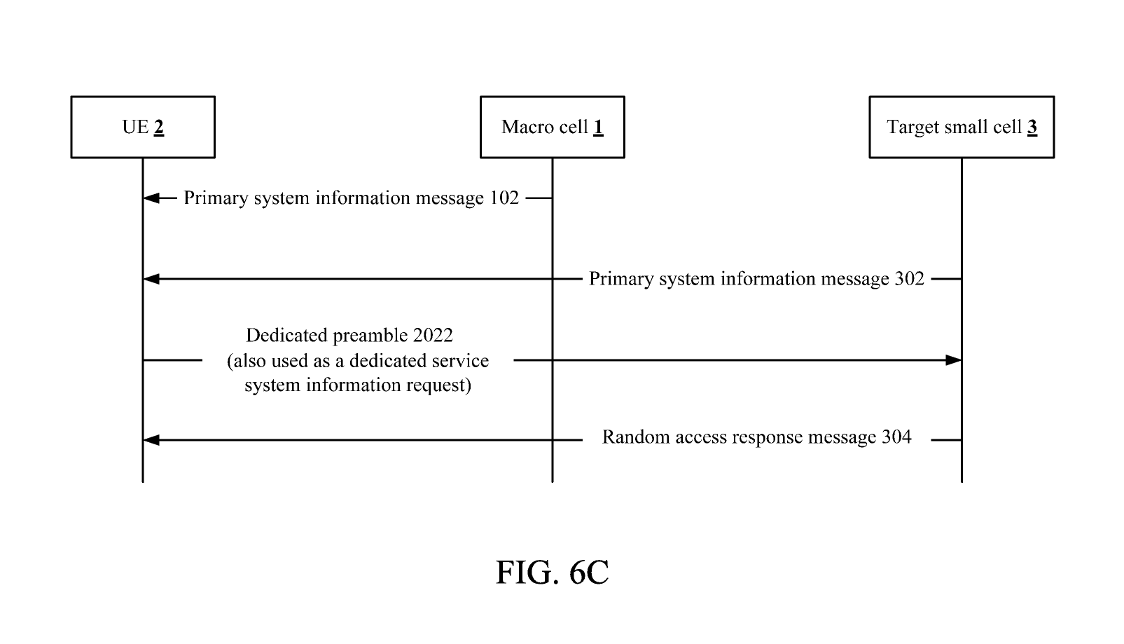

A sixth embodiment of the present invention is shown in FIGS. 6A-6C. The sixth embodiment is an extension of the first embodiment. FIGS. 6A-6C depict different implementation scenarios in which the UE 2 requests dedicated service system information from the small cell 3. This embodiment differs from the previous embodiments that, the small cell 3 transmits also a primary system information message 302 as well. Because the common system information is already comprised in the primary system information message 102 transmitted by the macro cell 1, the primary system information message 302 transmitted by the small cell 3 carries second essential system information of the small cell 3 without having to include the common system information. In other words, unlike the second embodiment, each of the small cells 3 transmits the essential system information itself in this embodiment.

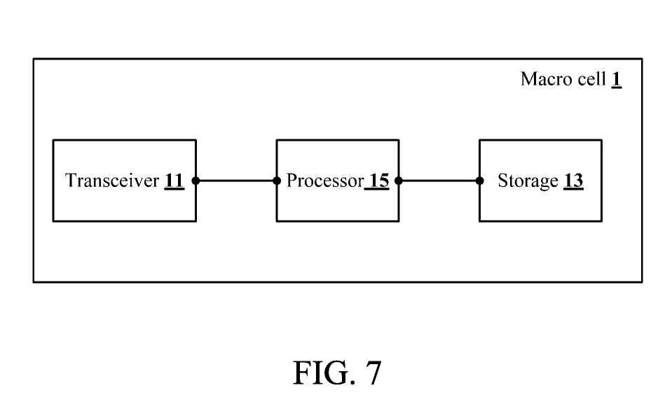

A seventh embodiment is shown in FIG. 7. FIG. 7 is a schematic view of the macro cell 1 according to the present invention. The macro cell 1 comprises a transceiver 11, a storage 13 and a processor 15. The processor 15 is electrically connected to the transceiver 11 and the storage 13. As described in the first embodiment, the storage 13 stores first essential system information of the macro cell 1. The processor 15 determines common system information between the macro cell 1 and the small cells 3, and stores the common system information into the storage 13. Then the processor 15 generates a primary system information message 102 that carries the first essential system information and the common system information. Next, the processor 15 periodically transmits the primary system information message 102 via the transceiver 11.

As in the implementations described in the second embodiment, the mobile communication system MCS provides a plurality of dedicated service types, and the primary system information message 102 further carries second essential system information of each of the small cells 3. The second essential system information of each small cell 3 comprises service summary information indicating at least one of the dedicated service types provided by the small cell 3.

In the implementation scenario shown in FIG. 2A, the dedicated service system information request message 308 is carried in an uplink data signal in the RRC connection status, i.e., the dedicated service system information request message 308 is transmitted via an allocated uplink resource. In the implementation scenario shown in FIG. 2B, the dedicated service system information request message is included in the RRC connection message 204 of the random access procedure, i.e., the RRC connection message 204 is also used as the dedicated service system information request message. In the implementation scenario shown in FIG. 2C, the storage 13 further stores a plurality of preambles including a plurality of dedicated preambles. The dedicated preambles and the dedicated service types have a correspondence relationship therebetween, and each of the dedicated preambles is also used as a dedicated service system information request message.

For the third embodiment, the second initial access information of the second essential system information of each of the small cells 3 excludes PRARCH resource information either. In the implementation scenario shown in FIG. 3A, the processor 15 further receives the dedicated service system information request message 206 from the UE 2 via the transceiver 11. The dedicated service system information request message 206 indicates a target dedicated service type among the dedicated service types. The UE 2 generates the dedicated service system information request message 206 according to the service summary information included in the second essential system information.

Then the processor 15 selects at least one target small cell 3 from the small cells 3 according to the target dedicated service type, and generates a push message 108 carrying a dedicated service system information transmission indication. Meanwhile, the processor 15 generates also a dedicated service system information response message 110 carrying an identity of each of the at least one target small cell 3. Next, the processor 15 transmits a push message 108 to the at least one target small cell 3 so that the at least one target small cell 3 periodically transmits a dedicated service system information message 308 carrying dedicated service contents of the target dedicated service type within a specific time interval. Meanwhile, the processor 15 also transmits a dedicated service system information response message 110 to the UE 2 via the transceiver 11.

Similarly in the implementation scenario shown in FIG. 3A, the dedicated service system information request message 206 is carried in an uplink data signal in an RRC connection status. In the implementation scenario shown in FIG. 3B, the dedicated service system information request message is included in the RRC connection message 204 of the random access procedure. In the implementation scenario shown in FIG. 3C, each of the dedicated preambles stored in the storage 13 is also used as the dedicated service system information request message, so when one of the dedicated preambles is received by the processor 15 from the UE 2 via the transceiver 11, the processor 15 further determines the target dedicated service type according to the correspondence relationship and uses the random access response message also as the dedicated service system information response message.

For the fourth embodiment, the macro cell 1 and the small cells 3 use the same PRACH resources therebetween, and the second initial access information of the second essential system information of each of the small cells excludes the PRACH resource information. In this case, the preambles stored in the storage 13 are further divided into a first group associated with the macro cell 1 and a second group associated with the small cells 3. This division may be done by a control device of the backhaul network or by the macro cell 1. Besides, in the implementation scenario shown in FIG. 4C, the preambles of the second group include a plurality of dedicated preambles. Similarly, the dedicated preambles and the dedicated service types have a correspondence relationship therebetween, so each of the dedicated preamble is also used as the dedicated service system information request message.

For the fifth embodiment, the macro cell 1 and the small cells 3 are in a timing synchronization status. The second initial access information of the second essential system information of each of the small cells 3 excludes the PRACH resource information either. As described previously, the dedicated preambles stored in the storage 13 and the small cells 3 also have a correspondence relationship therebetween, so after receiving the dedicated preamble 2032 transmitted by the UE 2 from the PRACH via the transceiver 11, the processor 15 parses the preamble sequence 112 of the dedicated preamble 2032 and transmits the preamble sequence 112 to the target small cell among the small cells 3 according to the correspondence relationship so that the target small cell transmits the random access response message 304 to the UE 2 according to the preamble sequence.

Then the processor 15 transmits the timing advance response message 114 carrying the timing advance information to the UE 2 via the transceiver 11 so that the UE 2 performs a timing advance correction according to the downlink timing, the timing advance information and the transmission time difference between the macro cell 1 and the target small cell 3. As described previously, the UE 2 may calculate the transmission time difference based on a receipt time difference between receipt of the timing advance response message 114 and receipt of the random access response message 304. Further in the implementation scenario shown in FIG. 5C, the dedicated preambles and the dedicated service types have another correspondence relationship therebetween, so each of the dedicated preambles may also be used as the dedicated service system information request message.

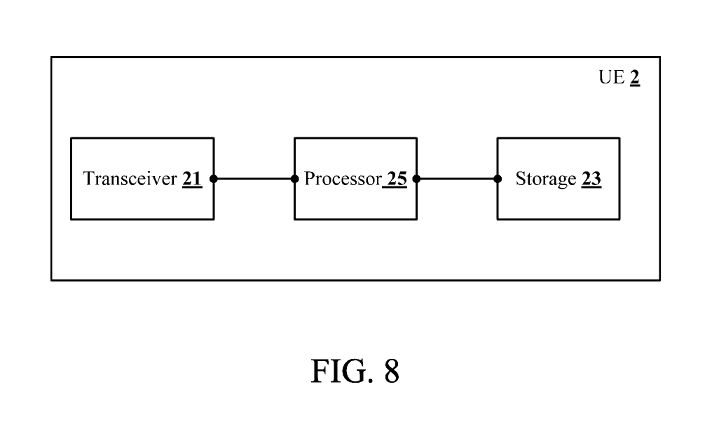

An eighth embodiment of the present invention is shown in FIG. 8. FIG. 8 is a schematic view of the UE 2 according to the present invention. The UE 2 comprises a transceiver 21, a storage 23 and a processor 25. The processor 25 is electrically connected to the transceiver 21 and the storage 23. The processor 25 receives the primary system information message 102 from the macro cell 1 via the transceiver 21, and generates a dedicated service system information request message 206 according to the primary system information message 102. The processor 25 transmits the dedicated service system information request message 206 to one of the small cells 3 (i.e., the target small cell 3 described in the previous embodiments) via the transceiver 21 so that the target small cell 3 transmits the dedicated service system information message 308 through periodical broadcasting within a specific time interval or transmits the dedicated service system information message 308 through dedicated signaling.

The mobile communication system provides a plurality of dedicated service types. The primary system information message 102 comprises common system information between the macro cell 1 and the small cells 3, first essential system information of the macro cell 1, and second essential system information of each of the small cells 3. The second essential system information of each small cell 3 comprises service summary information indicating at least one of the service types provided by the small cell 3. As described in the first embodiment, the common system information may be one of a system channel bandwidth, a base station re-selection parameter, emergency information, and any combination thereof.

In other embodiments (e.g., in the third embodiment), the dedicated service system information request message 206 may be transmitted to the target small cell 3 via the macro cell 1. In still other embodiments (e.g., in the second to the fifth embodiments), the first essential system information of the macro cell 1 comprises first initial access information, first information to access other SIBs, first service summary information, first service relevant SIBs status information and a first system information change indication, and the second essential system information of each of the small cells comprises second initial access information, second information to access other SIBs, second service summary information, second service relevant SIBs status information and a second system information change indication. However, in other embodiments (e.g., in the third to the fifth embodiments), the second initial access information of the second essential system information of each of the small cells excludes the PRACH resource information.

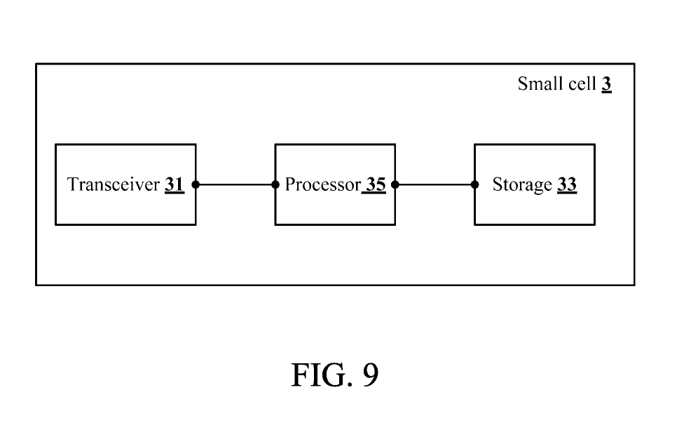

A ninth embodiment of the present invention is shown in FIG. 9. FIG. 9 is a schematic view of a small cell 3 of the present invention. The mobile communication system MCS comprises the macro cell 1 and a plurality of small cells 3 (including the target small cell and other small cells 3). The small cell 3 comprises a transceiver 31, a storage 33 and a processor 35. The processor 35 is electrically connected to the transceiver 31 and the storage 33. The processor 35 receives a dedicated service system information request message 206 via the transceiver 31, and transmits the dedicated service system information message 308 through periodical broadcasting within a specific time interval or transmits the dedicated service system information message 308 through dedicated signaling according to the dedicated service system information request message 206.

The dedicated service system information request message 206 is generated according to the primary system information message 102 or the primary system information message 302 after the primary system information message 102 is received from the macro cell or the primary system information message 302 is received from the small cell by the UE 2. The mobile communication system provides a plurality of dedicated service types. The primary system information message 102 comprises common system information between the macro cell 1 and the small cells 3, first essential system information of the macro cell 1, and second essential system information of each of the small cells 3. The second essential system information of each small cell 3 comprises service summary information (i.e., the second service summary information) indicating at least one of the service types provided by the small cell 3.

As described in the first embodiment, the common system information may be one of a system channel bandwidth, a base station re-selection parameter, emergency information, and any combination thereof. The first essential system information of the macro cell comprises first initial access information, first information to access other SIBs, first service summary information, first service relevant SIBs status information and a first system information change indication, and the second essential system information of each of the small cells 3 comprises second initial access information, second information to access other SIBs, second service summary information, second service relevant SIBs status information and a second system information change indication.

According to the above descriptions, the system information transmission mechanism of the present invention periodically transmits a primary system information message carrying common system information between the macro cell and each of the small cells and first essential system information of the macro cell itself via the macro cell, and allows the UE to request dedicated service system information corresponding to a service type currently needed from the small cell according to the service type currently needed. Thereby, the present invention can reduce the number of SIBs that need be broadcasted periodically and continuously and the information amount that is periodically broadcasted by base stations in the mobile communication system so as to reduce the consumption of system resources and signal interferences between base stations and to maximize the possibility of back compatibility of future mobile communication systems.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A macro cell for a mobile communication system, the mobile communication system comprising the macro cell and a plurality of small cells, the macro cell comprising:
a transceiver;
a storage, being configured to store first essential system information of the macro cell;
a processor electrically connected to the transceiver and the storage, being configured to execute the following operations:
determining common system information between the macro cell and the small cells;
storing the common system information into the storage;
generating a primary system information message carrying the first essential system information and the common system information; and
periodically transmitting the primary system information message via the transceiver.

2. The macro cell of claim 1, wherein each of the small cells transmits another primary system information message respectively, and each of the another primary system information messages carries second essential system information and does not carry the common system information.

3. The macro cell of claim 1, wherein the mobile communication system provides a plurality of dedicated service types, the primary system information message further carries second essential system information.

4. The macro cell of claim 3, wherein the first essential system information of the macro cell comprises first initial access information, first information to access other system information blocks (SIBs), first service summary information, first service relevant SIBs status information and a first system information change indication, and the second essential system information of each of the small cells comprises second initial access information, second information to access other SIBs, second service summary information, second service relevant SIBs status information and a second system information change indication;
wherein the first service summary information indicates at least one of the dedicated service types provided by the macro cell and the second service summary information of each of the small cell indicates at least one of the dedicated service types of the corresponding small cell.

5. The macro cell of claim 4, wherein the storage further stores a plurality of preambles including a plurality of dedicated preambles, the dedicated preambles have a correspondence relationship with the dedicated service types, and each of the dedicated preambles acts as a dedicated service system information request message.

6. The macro cell of claim 4, wherein the second initial access information of the second essential system information of each of the small cells excludes physical random access channel resource information, and the processor is further configured to execute the following operations:
receiving a dedicated service system information request message from a user equipment (UE) via the transceiver, wherein the dedicated service system information request message indicates a target dedicated service type among the dedicated service types, and the UE generates the dedicated service system information request message according to the second service summary information of each of the small cells;
selecting at least one target small cell from the small cells according to the target dedicated service type;
generating a push message carrying a dedicated service system information transmission indication;
generating a dedicated service system information response message carrying an identity of each of the at least one target small cell;
transmitting the dedicated service system information response message to the UE via the transceiver; and
transmitting the push message to the at least one target small cell so that the at least one target small cell periodically transmits a dedicated service system information message within a specific time interval, the dedicated service system information message carries a dedicated service content of the target dedicated service type.

7. The macro cell of claim 6, wherein the dedicated service system information request message is included in a Radio Resource Control (RRC) connection request message of a random access procedure or included in an uplink data signal in an RRC connection status.

8. The macro cell of claim 6, wherein the storage further stores a plurality of preambles including a plurality of dedicated preambles, the dedicated preambles have a correspondence relationship with the dedicated service types, and the UE uses one of the dedicated preambles as the dedicated service system information request message;
wherein when one of the dedicated preambles is received via the transceiver from a UE, the processor further determines the target dedicated service type according to the correspondence relationship, and the dedicated service system information response message is included in the random access response message.

9. The macro cell of claim 4, wherein the macro cell and the small cells use a same physical random access channel resource, the second initial access information of the second essential system information of each of the small cells excludes physical random access channel resource information, and the storage further stores a plurality of preambles that are divided into a first group associated with the macro cell and a second group associated with the small cells.

10. The macro cell of claim 9, wherein the preambles in the second group include a plurality of dedicated preambles which have a correspondence relationship with the dedicated service types, and each of the dedicated preambles acts as a dedicated service system information request message.

11. The macro cell of claim 4, wherein the macro cell and the small cells are in a timing synchronization status, the second initial access information of the second essential system information of each of the small cells excludes physical random access channel resource information, the storage further stores a plurality of preambles including a plurality of dedicated preambles, the dedicated preambles have a correspondence relationship with the small cells, and the processor further executes the following operations:
receiving a dedicated preamble transmitted by a UE from a physical random access channel via the transceiver;
parsing a preamble sequence of the dedicated preamble, and transmitting the preamble sequence to a target small cell among the small cells according to the correspondence relationship so that the target small cell transmits a random access response message to the UE based on the preamble sequence; and
transmitting a timing advance response message carrying timing advance information to the UE via the transceiver so that the UE performs a timing advance correction according to a downlink timing, the timing advance information and a transmission time difference between the macro cell and the target small cell;
wherein the UE calculates the transmission time difference based on a receipt time difference between receipt of the timing advance response message and receipt of the random access response message.

12. The macro cell of claim 10, wherein the dedicated preambles and the dedicated service types have another correspondence relationship therebetween, and each of the dedicated preambles acts as a dedicated service system information request message.

13. The macro cell of claim 1, wherein the macro cell is a virtual macro cell consisting of a plurality of specific small cells, and the primary system information message is transmitted periodically by the specific small cells or a part of the specific small cells.

14. A user equipment (UE) for a mobile communication system, the mobile communication system comprising a macro cell and a plurality of small cells, the UE comprising:
a transceiver;
a storage;
a processor electrically connected to the transceiver and the storage, being configured to execute the following operations:
receiving a primary system information message from the macro cell via the transceiver;
generating a dedicated service system information request message according to the primary system information message; and
transmitting the dedicated service system information request message to a target small cell among the small cells via the transceiver so that the target small cell transmits a dedicated service system information message through periodical broadcasting within a specific time interval or transmits the dedicated service system information message through dedicated signaling;
wherein the mobile communication system provides a plurality of dedicated service types, the primary system information message comprises common system information between the macro cell and the small cells, first essential system information of the macro cell, and second essential system information of each of the small cells, and the second essential system information of each of the small cells comprises service summary information indicating at least one of the dedicated service types provided by the corresponding small cell.

15. The UE of claim 14, wherein the dedicated service system information request message is transmitted to the target small cell via the macro cell.

16. The UE of claim 14, wherein the first essential system information of the macro cell comprises first initial access information, first information to access other SIBs, first service relevant SIBs status information and a first system information change indication, and the second essential system information of each of the small cells comprises second initial access information, second information to access other SIBs, second service relevant SIBs status information and a second system information change indication.

17. A small cell for a mobile communication system, the mobile communication system comprising a macro cell, the small cell and a plurality of other small cells, the small cell comprising:
a transceiver;
a storage; and
a processor electrically connected to the transceiver and the storage, being configured to receive a dedicated service system information request message from a UE via the transceiver, and transmit a dedicated service system information message through periodical broadcasting within a specific time interval or transmit the dedicated service system information message through dedicated signaling according to the dedicated service system information request message;
wherein the UE receives a primary system information message from the macro cell to generate the dedicated service system information request message according to the primary system information message, the mobile communication system provides a plurality of dedicated service types, the primary system information message comprises common system information between the macro cell and the small cell as well as the other small cells, first essential system information of the macro cell, second essential system information of the small cell and second essential system information of each of the other small cells, the second essential system information of the small cell comprises service summary information indicating at least one of the dedicated service types provided by the small cell, and the second essential system information of each of the other small cells comprises service summary information indicating at least one of the dedicated service types provided by the corresponding other small cell.

18. The small cell of claim 17, wherein the first essential system information of the macro cell comprises first initial access information, first information to access other SIBs, first service summary information, first service relevant SIBs status information and a first system information change indication, and the second essential system information of each of the small cell and the other small cells further comprises second initial access information, second information to access other SIBs, second service relevant SIBs status information and a second system information change indication.

19. A small cell for a mobile communication system, the mobile communication system comprising a macro cell, the small cell and a plurality of other small cells, the mobile communication system providing a plurality of dedicated service types, the UE receiving a primary system information message from the macro cell, and the primary system information message comprising common system information between the macro cell and the small cell as well as the other small cells and first essential system information of the macro cell, the small cell comprising:
a transceiver;
a storage; and
a processor electrically connected to the transceiver and the storage, being configured to transmit another primary system information message via the transceiver, receive a dedicated service system information request message from a UE, and transmit a dedicated service system information message through periodical broadcasting within a specific time interval or transmit the dedicated service system information message through dedicated signaling according to the dedicated service system information request message;
wherein the another primary system information message comprises second essential system information and excludes the common system information, and the second essential system information comprises service summary information indicating at least one of the dedicated service types provided by the small cell.

20. The small cell of claim 19, wherein the first essential system information of the macro cell comprises first initial access information, first information to access other SIBs, first service summary information, first service relevant SIBs status information and a first system information change indication, and the second essential system information of the small cell further comprises second initial access information, second information to access other SIBs, second service relevant SIBs status information and a second system information change indication.
